(19) United States
(12) Patent Application Publication
(10) Pub. No.: US 2007/0101577 A1
(43) Pub. Date: May 10, 2007

(54) Fruit coring device for producing a closed bore

(76) Inventor: George Mauro, Salem, NH (US)

Correspondence Address: DAVIS & BUJOLD, P.L.L.C., 112 PLEASANT STREET, CONCORD, NH, 03301, US

(21) Appl. No.: 10/534,949

(22) PCT Filed: Nov. 13, 2003
(86) PCT No.: PCT/US03/36385

§ 371 Date: May 16, 2005

Related U.S. Application Data
(63) Continuation-in-part of application No. 10/294,246, filed on Nov. 14, 2002, now abandoned.
(63) Continuation of application No. 10/668,737, filed on Sep. 23, 2003.

(51) Int. Cl. A47J 23/00

(52) U.S. Cl. 30/113.1

(57) ABSTRACT

A fruit coring device including a handle and a tubular member having first and second ends. The tubular member defines a longitudinal axis and has an interior region. One end of the circular tubular member is integral or fast with the handle and the second end defines a member cutting edge. The fruit coring device includes a blade with a cutting edge supported within the circular interior of the circular tubular member substantially normal to the member cutting edge.

### FIELD OF THE INVENTION

The invention relates to a device for removing the core of a fruit, particularly though not exclusively, an apple, to leave a closed ended bore (blind hole) to facilitate retention of a filling during baking to produce a baked fruit, e.g. an apple.

### BACKGROUND OF THE INVENTION

Typical coring devices for apples are designed to remove the apple core by removing a plug, including the core, from a bore which extends completely through the apple. An example of such a device is illustrated in FIG. 1. This prior art device comprises a part circular elongate blade 1 having serrated edges 2 extending for much of the length of the blade from a handle 3 to a pointed blade end 4. The pointed end 4 is inserted, usually from the stalk end of the apple, and the device is then rotated about a longitudinal axis defined by the blade while the blade 1 is pushed into the apple so that the teeth of the serrated edges 2 cut or tear the apple about its core until the blade 1 projects from the end of the apple opposite the stalk. The device is then removed, often leaving the core plug containing the core in place for separate removal, thereby adding a separate step in the removal of the core and leaving a bore open at both ends which hinders or prevents the retention of a filling during a baking operation.

In another prior art arrangement a circular tube, having a serrated circular edge extends away from a handle to which it is connected by a part circular member. This prior art device has similar drawbacks to those described with reference to FIG. 1.

### OBJECT OF THE INVENTION

It is an object of the present invention to provide an improved coring device suitable for use in easily removing the core of an apple in one step while providing a closed ended bore to provide for retention of a filling in the bore during baking to produce a baked apple.

It is also an object of the present invention to provide such a coring device for apples which is economical and easy to manufacture while having a long life expectancy and great durability and reliability.

### SUMMARY OF THE INVENTION

The present invention provides a fruit coring device comprising a handle and a tubular member having first and second ends and defining a longitudinal axis, the tubular member having an interior region, the first end of the tubular member being fast with the handle and the second end defining a member cutting edge and at least one blade having a blade cutting edge, the blade(s) being support within the interior region of the tubular member such that the blade cutting edge lies substantially in a plane defined by the member cutting edge.

The member cutting edge may be defined by at least one taper formed in the member, preferably converging tapers formed in the member with each taper having an angle of about 15° with respect to the axis.

It is to be understood that the term “cylindrical”, as used hereinafter and in the appended claims, means any shape that is circular or substantially circular such as, for example, octagonal, hexagonal, a square with rounded corners, other polygonal shapes, a ring, or a tubular ring, etc., regardless of whether or not the tubular member includes an air bleed passage. Generally speaking, the substantially cylindrical cutting member or cylindrical tubular member may comprise a plurality of planar surfaces interconnected with one another into a generally circular or oval configuration to form a leading cutting edge for cutting a bore in fruit. It is to be appreciated that the term “cylindrical” is also intended to cover arrangements in which the cutting edge is only partially cylindrical, e.g., the cutting edge only extends 180 degrees or greater. If desired, the member cutting edge may be serrated to facilitate cutting a bore within the fruit.

The handle preferably has two opposed extensions extending away from the longitudinal axis.

The blade may be a single blade, a pair of opposed blades or a first pair of blades and a second pair of blades with the first and second pair of blades extending perpendicular to one another.

The cutting member or tubular member may have a substantially continuous side wall extending from the first to the second end or merely may have a substantially continuous leading second end which is connected to the handle by two or more legs or some other rigid support to securely attach or affix the tubular member to the handle and prevent movement of the handle relative to the tubular member.

A sidewall of the cutting member or tubular member may be provided with an air passageway to allow air to bleed into the apple or fruit as the core is removed therefrom. This facilitates easier removal of the core as it substantially lessens the vacuum created within the apple or fruit during core removal.

### BRIEF DESCRIPTION OF THE DRAWINGS

The invention will now be described, by way of example, with reference to the accompanying drawings, in which:

FIG. 1 illustrates a prior art apple corer;

FIG. 2 is a perspective view of the apple coring device of the present invention;

FIG. 3 is a fragmentary cross-section taken on line 3-3 of FIG. 2;

FIG. 4 is a cross-section taken on line 4-4 of FIG. 2;

FIG. 5 is a fragmentary view of the handle portion of FIG. 2 with an optional ring to limit penetration of the device into an apple being cored;

FIG. 6 is a fragmentary view of an alternative cutting edge to that of FIG. 1;

FIG. 7 is a diagrammatic perspective view of an alternative embodiment of the device of the present invention;

FIG. 7A is a simplified diagrammatic plan view of FIG. 7 only showing the tubular member and the cutting blade for reasons of clarity;

FIG. 8 is a diagrammatic perspective view of another embodiment of the device of the present invention;

FIG. 8A is a simplified diagrammatic plan view of FIG. 8 only showing the tubular member and the cutting blades for reasons of clarity;

FIG. 8B is a simplified diagrammatic plan view of an alternative embodiment of FIGS. 8 and 8A only showing the tubular member and the cutting blade(s) for reasons of clarity;

FIG. 9 is a diagrammatic perspective view of yet another embodiment of the device of the present invention;

FIG. 9A is a diagrammatic cross sectional view taken along line 9-9 of FIG. 9;

FIG. 10 is a simplified diagrammatic plan view of a further embodiment of the present invention only showing the tubular member and the cutting blade for reasons of clarity;

FIG. 11 is a simplified diagrammatic plan view of a still further embodiment of the present invention only showing the tubular member and the cutting blade for reasons of clarity;

FIG. 12 is a diagrammatic perspective view of a still further embodiment of the device of the present invention;

FIG. 12A is a simplified diagrammatic plan view of FIG. 12 only showing the tubular member and the cutting blade for reasons of clarity;

FIG. 12B is a simplified diagrammatic plan view of an alternative embodiment of FIGS. 12 and 12A only showing the tubular member and the cutting blades for reasons of clarity;

FIG. 12C is a simplified diagrammatic plan view of yet another embodiment of FIGS. 12 and 12A only showing the tubular member and the cutting blades for reasons of clarity

FIG. 13 is a diagrammatic partial cross sectional view of an embodiment of the tubular member with a thin wire cutting blade;

FIG. 14 is a diagrammatic partial cross sectional view of another embodiment of the tubular member and cutting blade(s);

FIG. 15 is a diagrammatic partial cross sectional view of yet another embodiment of the tubular member and cutting blade(s);

FIG. 16 is a diagrammatic perspective view of another embodiment of the device of the present invention;

FIG. 16A is a simplified diagrammatic plan view of a yet a further embodiment of the present invention only showing the tubular member and the cutting blade for reasons of clarity;

FIG. 17 is a simplified diagrammatic plan view of another embodiment of the present invention only showing the tubular member and the cutting blade for reasons of clarity;

FIG. 18 is a simplified diagrammatic plan view of yet another embodiment of the present invention only showing the tubular member and the cutting blade for reasons of clarity;

FIG. 19 is a simplified diagrammatic plan view of a still further embodiment of the present invention only showing the tubular member and the cutting blade for reasons of clarity;

FIG. 20 is a simplified diagrammatic plan view of another embodiment of the present invention only showing the tubular member and the cutting blade for reasons of clarity;

FIG. 21 is a diagrammatic perspective view of yet another embodiment of the device of the present invention;

FIG. 21A is a simplified diagrammatic plan view of FIG. 21 only showing the tubular member and the cutting blade for reasons of clarity;

FIG. 21B is a simplified diagrammatic plan view of the tubular member stamped from a piece of sheet metal;

FIG. 22A is a diagrammatic front elevational view of still another embodiment of the device of the present invention;

FIG. 22B is a diagrammatic top plan view of FIG. 22A; and

FIG. 22C is a diagrammatic partial perspective view of FIG. 22A.

### DESCRIPTION OF PREFERRED EMBODIMENTS

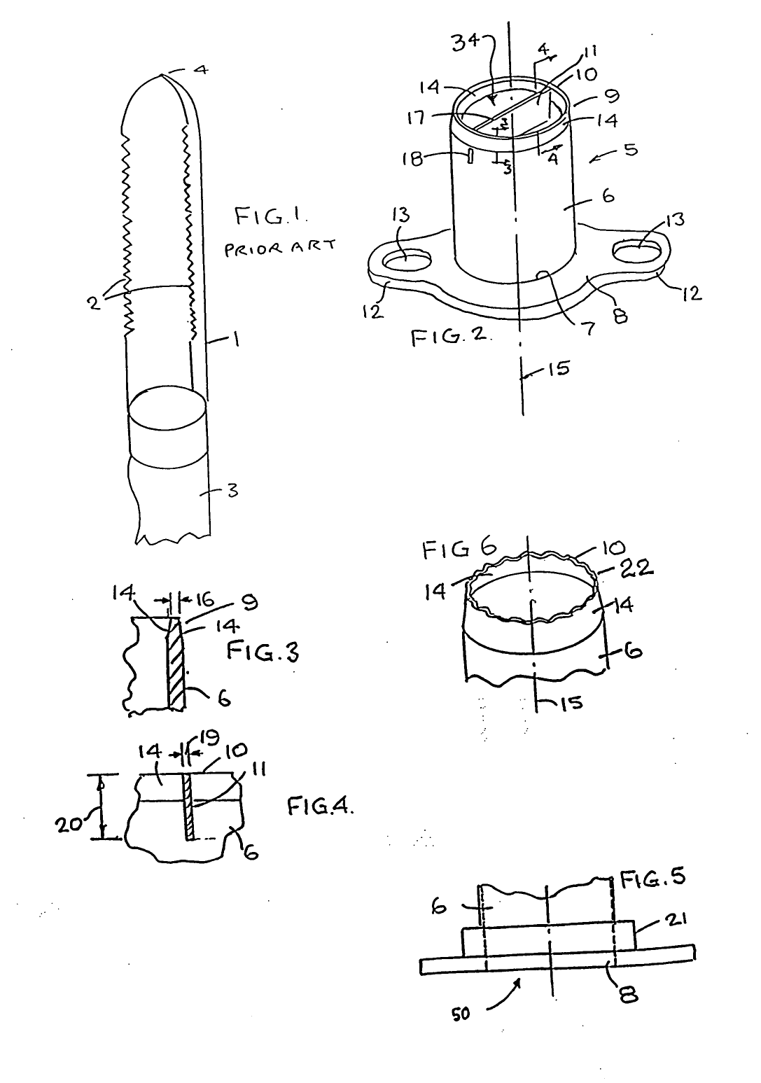

Referring first to FIG. 2, an apple coring device 5 comprises a right circular substantially cylindrical cutting member or tubular member 6 extending from first end 7, attached a handle 8, to an opposite second end 9 which forms a leading cutting member edge or member cutting edge 10 traversed by a straight blade 11 attached within the tubular member 6.

The handle 8 may be integral with the first end 7 or made fast with the first end 7 by the use of a conventional attachment mechanism, e.g., a press fit, an adhesive, rivets, welding, etc., and defines a pair of opposed projections 12, each having a finger engaging opener 13.

The length of the tubular member 6 from the cutting edge 10 to the proximate surface of the handle 8 is about 1.7 inches and the inside diameter of the tubular member 6 is about 1.0 inches.

As best seen in FIGS. 2 and 3, the cutting edge 10 of the tubular member 6 is formed by inner and outer tapered surfaces 14, respectively, on the inside and outside of the tubular member 6, each having a taper angle of about 15° relative to the longitudinal axis 15 of the tubular member 6 to reduce the wall thickness of the tubular member from about 0.030 inches to the cutting edge which has a width 16 of about 0.005 inches or so.

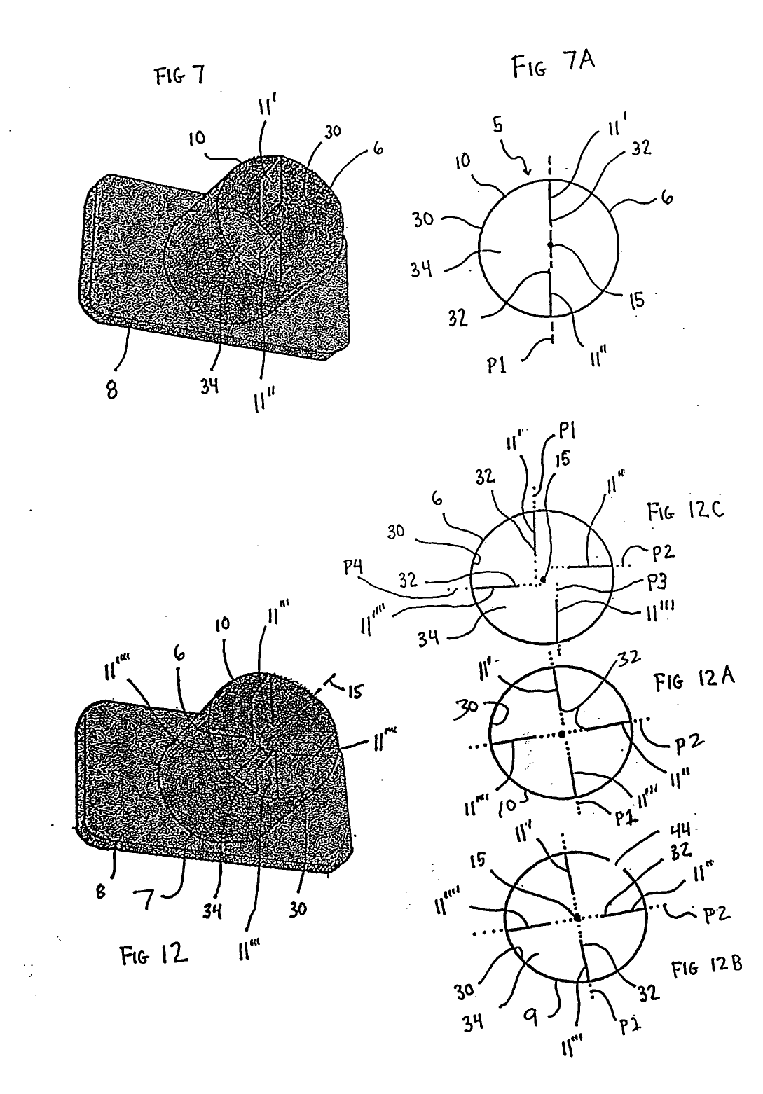

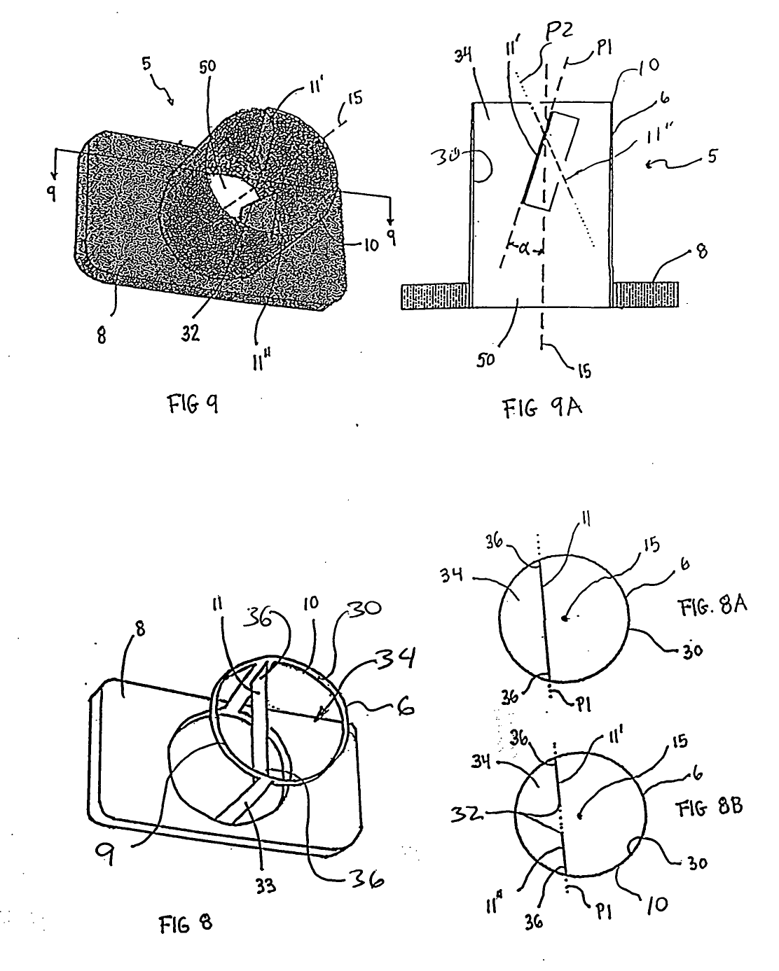

Extending diametrically across the cutting edge 10, defining an end of the tubular member 6, is a straight flat blade 11 having a cutting edge 17, which is positioned closely adjacent to and lying in a plane defined by the cutting edge 10 of the tubular member 6. The blade 11 may be firmly supported in slots 18 (one only being shown) located at the sidewall of the tubular member 6 or by other means that will be well known to those skilled in the art. The blade 11 extends from its straight cutting edge 17 along the axis toward the handle 8. The straight cutting edge has a thickness 19 (FIG. 4) of about 0.015 inches and the blade 11 has a width 20 extending along the axis 15 of about 0.5 inches.

In order to function to produce a closed ended bore in a small apple or some other fruit, one or more rings 21 may be provided (FIG. 5) to fit over the tubular member 6 against the handle 8 to reduce the depth of the bore that can be produced by the device 5.

In an alternative embodiment (FIG. 6) the cutting edge 10 of the tubular member may be serrated 22 to aid in the initial penetration of the apple's skin.

To operate the device 5, an operator will center the cutting edge 10 of the tubular member 6 over the desired apple or other fruit to be cored, usually from the stalk end of the apple or other fruit, and push the device 5, without twisting, into the apple or other fruit until the handle 8 contacts or abuts with the apple or other fruit. Following initial penetration within the apple or fruit, the device 5 may be realigned with respect to the apple or fruit to ensure proper and accurate alignment of the device 5 with the core to facilitate removal of the fruit core. The handle 8 is then used to turn or twist the device 5, including the blade 11, relative to the apple or other fruit to be cored about the longitudinal axis 15 at least ¼ of a turn or so until the blade(s) sufficiently shears or separates the core from a remainder of the apple or other fruit. After this occurs, the operator then removes or pulls the device 5 out of the apple or other fruit with the tubular member 6 removing with it the fruit core plug which is retained within the interior region 34 of the device 5. With the core removed, this leaves a closed ended or bottomed bore in the apple or fruit which is able to accept, in leak proof manner, a filling used in the production of a baked apple, for example. Upon further use of the device 5 to remove a new core, upon repeating the above procedure, the new core will push the previously removed fruit core out through the opening 50 (see FIGS. 5 and 9, for example) formed in the handle 8 of the device 5 so that the new core will be thus be retained within the interior region 34 of the device 5. In the event that an opening 50 is not formed in the handle 8 of the device 5, the core will have to be removed from the interior region 34 of the device 5, via the second end 9 of the tubular member 6, by hand prior to removing a new core.

With reference now to FIGS. 7 and 7A, another embodiment of the apple coring device 5, according to the present invention, will now be described. As this embodiment is very similar to the preceding embodiments, only the differences between this embodiment and the preceding embodiments will be discussed in detail.

According to this embodiment, the blade 11 comprises diametrically opposed first and second blades 11′, 11″ which are both accommodated within the interior region 34 of the tubular member 6. Both of the first and second blades 11′, 11″ lie in and define a first plane P1 which is coincident with the longitudinal axis 15 of the device 5. Both of the first and second blades 11′, 11″ are securely and permanently affixed to the inner surface 30 of the tubular member 6 in a known manner, e.g., an adhesive, rivets, slots, welding, etc. The substantially radially inwardly facing edges 32 of the first and second blades 11′, 11″ are spaced from one another by a distance of between about 0.25 and 0.75 inches or so with the longitudinal axis 15 of the device 5 being equally spaced from each longitudinal edge.

The length of the tubular member 6 from the cutting edge 10 to the surface proximate the handle 8 is about 1 inch to 2.5 inches or so, preferably about 1.7 inches and the inside diameter of the tubular member 6 is about 0.25 inches to 2 inches or so, preferably about 1 inch. Each of the first and second blades 11′, 11″ has a thickness of about 0.015 inches, an axial length of between about 0.05 inches to 2.5 inches or so, preferably about 1.7 inches and a radial width of about 0.15 inches to 0.75 inches or so, preferably about 0.25 inches or so. This embodiment operates in a similar fashion to the previously discussed embodiments.

With reference now to FIGS. 8 and 8A, a further other embodiment of the apple coring device 5 according to the present invention will now be described. As this embodiment is very similar to the embodiment of FIG. 2, only the differences between this embodiment and the embodiments of FIG. 2 will be discussed in detail.

As with the embodiment of FIG. 2, only a single straight blade 11 is utilized which defines and lies a first plane P1. The first plane P1 lies parallel to but is spaced from or offset from and not coincident with the longitudinal axis 15 of the device 5. Both opposed ends 36 of the single blade 11 are securely and permanently affixed to the inner surface 30 of tubular member 6 in a known manner, e.g., an adhesive, rivets, slots, welding, etc. According to this embodiment, the tubular member 6 has a substantially continuous leading second end 9 which is connected to the handle 8 by at least one, preferably two or more legs or other rigid supports 33 to securely attach or affix the tubular member 6 to the handle 8 and prevent any axial and/or rotational movement of the tubular member 6 relative to the handle 8. That is, a portion of the sidewall, adjacent the first end 7 of the tubular member is removed and this removed sidewall provides access to the interior region 34 to assist with removed of the core, if desired, without significantly effecting the integrity of the tubular member 6.

The length of the tubular member 6 from the cutting edge 10 to the handle 8 is about 1 inch to 2.5 inches or so, preferably about 1.7 inches and the inside diameter of the tubular member 6 is about 0.25 inches to 2 inches or so, preferably about 1 inch. The single blade 11 has a thickness of about 0.015 inches, an axial length of between about 0.05 inches to 2.5 inches or so, preferably about 1.7 inches and a radial width of about 0.15 inches to 0.75 inches or so, preferably about 0.25 inches or so. This embodiment operates in a similar fashion to the embodiment of FIG. 2.

With reference now to FIG. 8B, a slight variation of the embodiment of the apple coring device 5 according to FIGS. 8 and 8A will now be described. As this embodiment is very similar to the embodiment of FIGS. 8 and 8A, only the differences between this embodiment and the embodiment of FIGS. 8 and 8A will be discussed in detail.

According to this embodiment, the straight blade 11 comprises first and second blades 11′, 11″ which are both supported adjacent the second end of the tubular member 6. Both of the first and second blades 11′, 11″ lie in and define a first plane P1 which extends parallel to but is spaced and offset from and not coincident with the longitudinal axis 15 of the device 5. A longitudinal edge of each of the first and second blades 11′, 11″ is securely and permanently affixed to the inner surface 30 of tubular member 6 in a known manner, e.g., an adhesive, rivets, slots, welding, etc. The radially inwardly facing edges 32 of the first and second blades 11′, 11″ are spaced from one another by a distance of between 0.25 and 2.50 inches.

The length of the tubular member 6 from the cutting edge 10 to the proximate surface of the handle 8 is about 1 inch to 2.5 inches or so, preferably about 1.7 inches and the inside diameter of the tubular member 6 is about 0.25 inches to 2 inches or so, preferably about 1 inch. Each of the first and second blades 11′, 11″ has a thickness of about 0.015 inches, an axial length of between about 0.05 inches to 2.5 inches or so, preferably about 1.7 inches and a radial width of about 0.15 inches to 0.75 inches or so, preferably about 0.25 inches or so. This embodiment operates in a similar fashion to the previously discussed embodiments.

With reference now to FIGS. 9 and 9A, yet another embodiment of the apple coring device 5 according to the present invention will now be described. As this embodiment is very similar to the embodiment of FIGS. 7 and 7A, only the differences between this embodiment and the embodiment of FIGS. 7 and 7A will be discussed in detail.

According to this embodiment, the blade 11 comprises diametrically opposed first and second blades 11′, 11″ which are both accommodated within the interior region 34 of the tubular member 6. The first blade 11′ lies in and defines a first plane P1 which forms an angle α of between 5 and 45 degrees with the longitudinal axis 15, preferably forms an angle of about 20 degrees. The first plane P1 intersects with the longitudinal axis 15 of the device 5. The second blade 11″ lies in and defines a second plane P2 which forms an angle of between 5 and 45 degrees with the longitudinal axis 15, preferably forms an angle of about 20 degrees. The second plane P2 intersects with the longitudinal axis 15 of the device 5 and also intersects with first plane P1. Both of the first and second blades 11′, 11″ are securely and permanently affixed to the inner surface 30 of the tubular member 6 in a known manner, e.g., an adhesive, rivets, slots, welding, etc. The radially inwardly facing edges of the first and second blades 11′, 11″ are spaced from one another by a distance of about 0.25 and 0.75 inches or so.

The length of the tubular member 6 from the cutting edge 10 to the proximate surface of the handle 8 is about 1 inch to 2.5 inches or so, preferably about 1.7 inches and the inside diameter of the tubular member 6 is about 0.25 inches to 2 inches or so, preferably about 1 inch. Each of the first and second blades 11′, 11″ has a thickness of about 0.015 inches, an axial length of between about 0.05 inches to 2.5 inches or so, preferably about 1.7 inches and a radial width of about 0.15 inches to 0.75 inches or so, preferably about 0.25 inches or so. This embodiment operates in a similar fashion to the previously discussed embodiments.

With reference now to FIG. 10, a slight variation of the embodiment of the apple coring device 5 according to FIGS. 2-5 will now be described. As this embodiment is very similar to the embodiment of FIGS. 2-5, only the differences between this embodiment and the embodiment of FIGS. 2-5 will be discussed in detail.

As with the embodiment of FIGS. 2-5, only a single straight blade 11 is utilized which defines and lies a first plane P1. The first plane P1 lies parallel to and is coincident with the longitudinal axis 15 of the device 5. Both opposed ends 36 of the single blade 11 are securely and permanently affixed and to the inner surface 30 of the tubular member 6 in a known manner, e.g., an adhesive, rivets, slots, welding, etc. An elongate recess, slot, trough or groove 38, for example, is formed longitudinally along the sidewall 40 of the tubular member 6 from the first end 7 to the second end 9 thereof. The elongate recess, slot, trough or groove 38 forms a bleed air passageway along the tubular member 6 to allow air to be supplied toward a base of the closed bottomed bore formed in the apple or the other fruit as the core is being removed therefrom. It is to be appreciated that as the core is being removed or extracted from the apple or other fruit, a significant amount of vacuum is generated within the apple or other fruit. The elongate recess, slot, trough or groove 38 provides a passageway which allows room air to be sucked into the apple or other fruit as the device 5 is removed, along with the core, from the apple or other fruit. The elongate recess, slot, trough or groove feature 38 facilitates easier removal of the core as it substantially lessens the vacuum created within the apple or fruit during core removal. It is to be appreciated that although the device 5 is describe as having a single blade 11, as one skill in the art would appreciate, any one of the other disclosed blade arrangements may be utilized in combination with the elongate recess, slot, trough or groove feature 38.

With reference now to FIG. 11, another slight variation of the embodiment of the apple coring device 5 according to FIGS. 2-5 will now be described. As this embodiment is very similar to the embodiment of FIGS. 2-5, only the differences between this embodiment and the embodiment of FIGS. 2-5 will be discussed in detail.

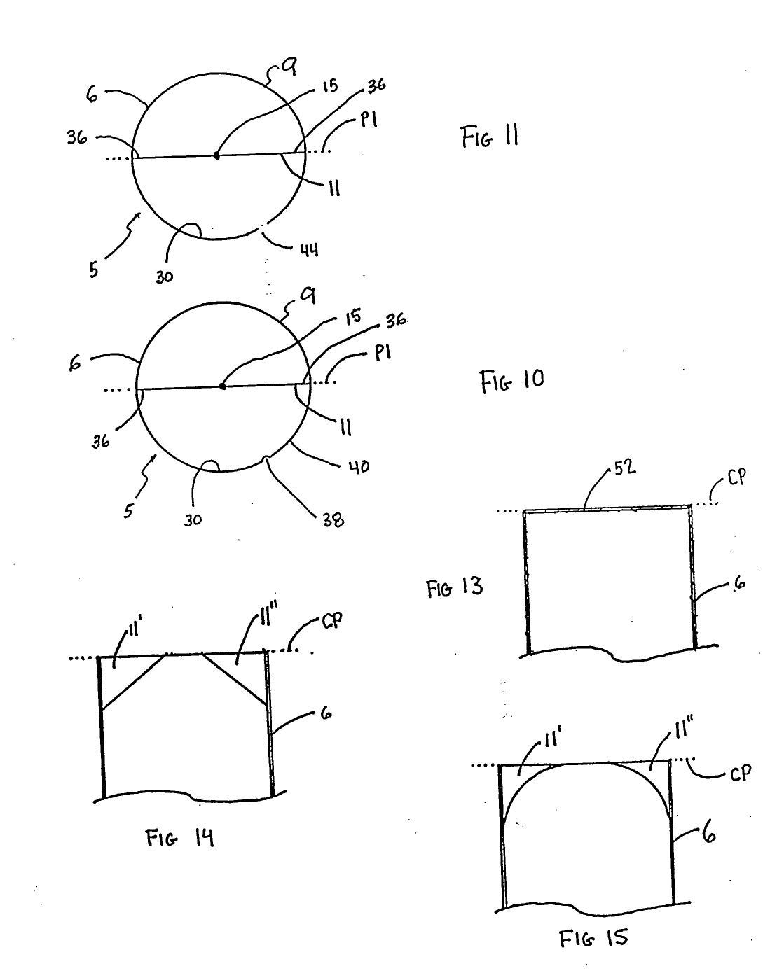

As with the embodiment of FIGS. 2-5, only a single straight blade 11 is utilized which defines and lies a first plane P1. The first plane P1 lies parallel to and is coincident with the longitudinal axis 15 of the device 5. Both opposed ends 36 of the single blade 11 are securely and permanently affixed and to the inner surface 30 of the tubular member 6 in a known manner, e.g., an adhesive, rivets, slots, welding, etc. An elongate cutout or gap 44, for example, is formed longitudinally along the sidewall 40 of the tubular member 6 from the first end to the second end 9 thereof. The elongate cutout or gap 44 forms an air passageway along the tubular member 6 which allows air to be supplied toward a base of the closed bottomed bore formed in the apple or the other fruit by the device 5 as the core is being removed therefrom. This elongate cutout or gap 44 significantly lessen the amount of vacuum generated within the apple or other fruit as the core is being removed or extracted from the apple or other fruit. The elongate cutout or gap 44 provides a passageway which allows room air to be sucked into the apple or other fruit as the device 5 is removed, along with the core, from the apple or other fruit. The elongate cutout or gap 44 feature facilitates easier removal of the core. It is to be appreciated that although the device 5 is describe as having a single blade 11, as one skill in the art would appreciate, any one of the other disclosed blade arrangements may be utilized in combination with the elongate cutout or gap feature 44 (see FIG. 12B discussed below, for example).

With reference now to FIGS. 12 and 12A, a still further embodiment of the apple coring device 5 according to the present invention will now be described. As this embodiment is very similar to the embodiment of FIGS. 7 and 7A, only the differences between this embodiment and the embodiment of FIGS. 7 and 7A will be discussed in detail.

According to this embodiment, the blade 11 comprises a first pair of diametrically opposed first and second blades 11′, 11′″ and a second pair of diametrically opposed first and second blades 11″, 11″″ which are all accommodated within the interior region 34 of the tubular member 6. The first pair of first and second blades 11′, 11′″ lie in and define a first plane P1 which is coincident with the longitudinal axis 15 of the device 5 and the second pair of first and second blades 11″, 11″″ lie in and define a second plane P2 which is also coincident with the longitudinal axis 15 of the device 5. The first plane P1 extends substantially normal to the second plane P2. Both pair of the first and second blades 11′, 11″ are securely and permanently affixed to the inner surface 30 of the tubular member 6 in a known manner, e.g., an adhesive, rivets, slots, welding, etc. The radially inwardly facing edges 32 of the first pair of first and second blades 11″″ are spaced from one another by a distance of between 0.10 and 0.5 inches, preferably about 0.25 inches or so with the longitudinal axis 15 of the device 5 being equally spaced from each longitudinal edge while the radially inwardly facing edges 32 of the second pair of first and second blades 11″, 11″″ are also spaced from one another by a distance of between 0.10 and 0.5 inches, preferably about 0.25 inches or so with the longitudinal axis 15 of the device 5 being equally spaced from each longitudinal edge.

The length of the tubular member 6 from the cutting edge 10 to the proximate surface of the handle 8 is about 1 inch to 2.5 inches or so, preferably about 1.7 inches and the inside diameter of the tubular member 6 is about 0.25 inches to 2 inches or so, preferably about 1 inch. Each of the first and second blades has a thickness of about 0.015 inches, an axial length of between about 0.05 inches to 2.5 inches or so, preferably about 1.7 inches and a radial width of about 0.15 inches to 0.75 inches or so, preferably about 0.25 inches or so. This embodiment operates in a similar fashion to the previously discussed embodiments.

With reference now to FIG. 12B, is essentially a combination of the embodiments of the apple coring device 5 according to FIGS. 11 and 12 and 12A. As this embodiment is very similar to those embodiments, only the differences between this embodiment and those embodiment will be discussed in detail.

According to this embodiment, the blade 11 comprises a first pair of diametrically opposed first and second blades 11′, 11′″ and a second pair of diametrically opposed first and second blades 11″, 11″″ which are all accommodated within the interior region 34 of the tubular member 6. The first pair of first and second blades 11′, 11′″ lie in and define a first plane P1 which is coincident with the longitudinal axis 15 of the device 5 and the second pair of first and second blades lie in and 11″, 11″″ define a second plane P2 which is also coincident with the longitudinal axis 15 of the device 5. The first plane P1 extends substantially normal to the second plane P2. Both pair of the first and second blades 11′, 11″, 11′″, 11″″ are securely and permanently affixed to the inner surface 30 of the tubular member 6 in a known manner, e.g., an adhesive, rivets, slots, welding, etc. The radially inwardly facing edges 32 of the first pair of first and second blades 11′″ are spaced from one another by a distance of between 0.10 and 0.5 inches, preferably about 0.25 inches or so with the longitudinal axis 15 of the device 5 being equally spaced from each longitudinal edge while the radially inwardly facing edges 32 of the second pair of first and second blades 11″″ are also spaced from one another by a distance of between 0.10 and 0.5 inches, preferably about 0.25 inches or so with the longitudinal axis 15 of the device 5 being equally spaced from each longitudinal edge.

An elongate cutout or gap 44 is formed longitudinally along the sidewall 40 of the tubular member 6 from the first end 7 to the second end 9 thereof. The elongate cutout or gap 44 forms an air passageway along the tubular member 6 to allow air to be supplied toward a base of the closed bottomed bore formed in the apple or the other fruit by the device 5 as the core is being removed therefrom. It is to be appreciated that as the core is removed or extracted from the apple or other fruit, a significant amount of vacuum is generated within the apple or other fruit. The elongate cutout or gap 44 provides a passageway which allow room air to be sucked into the apple or other fruit as the device 5 is removed, along with the core, from the apple or other fruit.

With reference now to FIG. 12C, yet another embodiment of the apple coring device 5 according to the present invention will now be described. As this embodiment is very similar to the embodiment of FIGS. 12 and 12A, only the differences between this embodiment and the embodiment of FIGS. 12 and 12A will be discussed in detail.

According to this embodiment, the blade 11 comprises a first pair of first and second blades 11′, 11′″ and a second pair of first and second blades 11″, 11″″ which are all accommodated within the interior region 34 of the tubular member 6. The first blade 11′ of the first pair of blades 11′, 11′″ lies in and defines a first plane P1 which extends parallel to but is spaced or offset from and not coincident with the longitudinal axis 15 of the device 5 while the second blade 11′″ of the first pair of blades lies 11′, 11′″ in and defines a third plane P3 which extends parallel to but is also spaced or offset from and not coincident with the longitudinal axis 15 of the device 5. The first plane P1 extends parallel to but is spaced from the third plane P3 by a distance of between about 0.075 and 0.33 inches or so.

The first blade 11″ of the second pair of blades 11″, 11″″ lies in and defines a second plane P2 which extends parallel to but is spaced or offset from and not coincident with the longitudinal axis 15 of the device 5 while the second blade 11″″ of the second pair of blades 11″, 11″″ lies in and defines a fourth plane P4 which extends parallel to but is also spaced or offset from and not coincident with the longitudinal axis 15 of the device 5. The second plane P2 extends parallel to but is spaced from the fourth plane P4 by a distance of between about 0.075 and 0.33 inches or so, for example. Both pairs of the first and second blades 11′, 11″, 11′″, 11″″ are securely and permanently affixed to the inner surface 30 of the tubular member 6 in a known manner, e.g., an adhesive, rivets, slots, welding, etc. The radially inwardly facing edges 32 of the first pair of first and second blades 11′, 11 ′″ are spaced from one another by a distance of between 0.10 and 0.5 inches, preferably about 0.25 inches or so while the radially inwardly facing edges 32 of the second pair of first and second blades 11″, 11″″ are also spaced from one another by a distance of between 0.10 and 0.5 inches, preferably about 0.25 inches or so.

The length of the tubular member 6 from the cutting edge 10 to the proximate surface of the handle 8 is about 1 inch to 2.5 inches or so, preferably about 1.7 inches and the inside diameter of the tubular member 6 is about 0.25 inches to 2 inches or so, preferably about 1 inch. Each blade of the first and second pair of blades has a thickness of about 0.015 inches, an axial length of between 0.05 inches to 2.5 inches or so, preferably about 1.7 inches and a radial width of about 0.15 inches to 0.75 inches or so, preferably about 0.25 inches or so. This embodiment operates in a similar fashion to the previously discussed embodiments.

With reference now to FIG. 13, a still further another embodiment of the apple coring device 5 according to the present invention will now be described. According to this embodiment, the blade 11 comprises a thin metallic wire 52, cable, rope, etc. which extends across the second end 9 of the tubular member. If desired, the thin metallic wire 52 can extend coincident with the longitudinal axis 15 or be spaced or offset therefrom. The thin metallic wire 52 must be sufficiently rigid to pass through the fruit without breaking while still being able to cut or form a closed bottom bore with the fruit upon rotation of the device 5 relative to the fruit. Typically, the thin metallic wire 52 has a thickness of between about 0.010 inches to about 0.25 inches or so, preferably between about 0.020 inches to about 0.065 inches.

Turning now to FIG. 14, a variation in the shape of the blade is shown. According to this embodiment, the blade 11 has a generally triangular shaped profile with one edge securely affixed to the inner surface of the tubular member 6. The design provides the blade with sufficient rigidity to pass through the fruit without breaking while still being able to shear the core from a remainder of the fruit. FIG. 15 is an embodiment very similar to FIG. 14, except that the profile of the blade is further modified to provide less blade surface when the device 5 is rotated with respect to the fruit to shear the core from a remainder of the fruit.

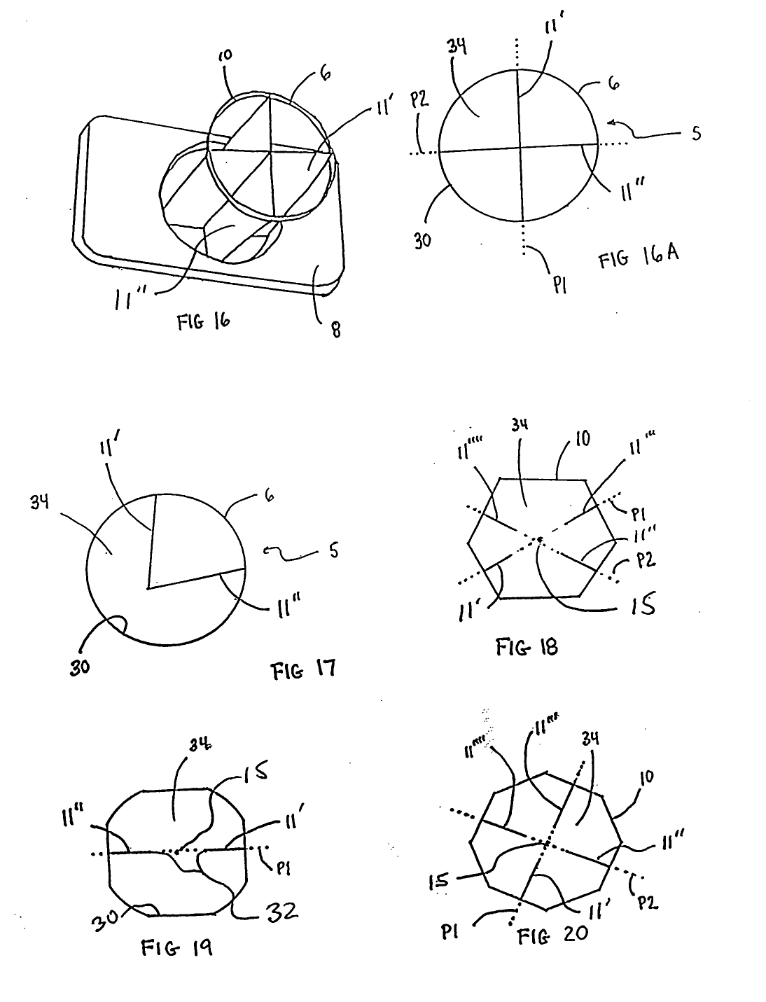

With reference now to FIG. 16, yet another embodiment of the apple coring device 5 according to the present invention will now be described. As this embodiment is very similar to the embodiment of FIG. 8, only the differences between this embodiment and the embodiment of FIG. 8 will be discussed in detail.

According to this embodiment, the blade 11 comprises first and second elongate blades 11′, 11″. The first and second elongate blades 11′, 11″ are fixedly attached to one another such that the first blade 11′ lies in a first plane P1 that extends normal to a plane P2 defined by the second blade 11″. The ring or tubular member 6 is supported in a spaced relationship from the handle 8 with the first and second elongate blades 11′, 11″ interconnecting the tubular member 6 with the handle 8. The tubular member 6 has a member cutting edge 10 which defines a member cutting edge plane and the blade cutting edges lie in the member cutting edge plane.

Turning now to FIG. 17, still another blade variation is shown. According to this embodiment, the blade 11 is “V-shaped” and comprises a pair of blades 11′, 11″ which a connected with one another along a common vertex. The opposed end of each of the blades 11′ and 11″ is connected to an inner surface 30 of the tubular member 6. This blade arrangement provides a core shearing action as the device is rotated with respect to the fruit to remove the core.

With reference to FIG. 18, a variation of the tubular member and a further blade variation are shown. According to this embodiment, the tubular member is not cylindrical but is, instead, hexagonal in transverse cross section. In addition, the blade 11 comprises a first pair of first and second blades 11′, 11′″ and a second pair of first and second blades 11″, 11″″ which are all accommodated within the interior region 34 of the tubular member 6. The first pair of blades 11′, 11′″ lies in and defines a first plane P1 which extends parallel to and is coincident with the longitudinal axis 15 of the device 5 while the second pair of blades lies 11′″ in and defines a second plane P2 which extends parallel to and is coincident with the longitudinal axis 15 of the device 5. The first and second planes P1, P2 extend substantially normal to one another. This arrangement of the tubular member tends to form a number air or relief passages in the fruit, as the device 5 is rotated relative to the fruit, thereby assisting with room air being sucked into the apple or other fruit as the device 5 is removed, along with the core, from the apple or other fruit.

With reference to FIG. 19, a further variation of the tubular member and a further blade variation are shown. According to this embodiment, the tubular member is substantially square in transverse cross section and the corners of the tubular member curved or arcuate is shape. This arrangement of the tubular member tends to form a number air or relief passages in the fruit, as the device 5 is rotated relative to the fruit, thereby assisting with room air being sucked into the apple or other fruit as the device 5 is removed, along with the core, from the apple or other fruit. The blade 11 comprises diametrically opposed first and second blades 11′, 11″ which are both accommodated within the interior region 34 of the tubular member 6. Both of the first and second blades 11′, 11″ lie in and define a first plane P1 which is coincident with the longitudinal axis 15 of the device 5. Both of the first and second blades 11′, 11″ are securely and permanently affixed to the inner surface 30 of the tubular member 6 in a known manner, e.g., an adhesive, rivets, slots, welding, etc. The substantially radially inwardly facing edges 32 of the first and second blades 11′, 11″ are spaced from one another by a distance of between about 0.25 and 0.75 inches or so with the longitudinal axis 15 of the device 5 being equally spaced from each longitudinal edge.

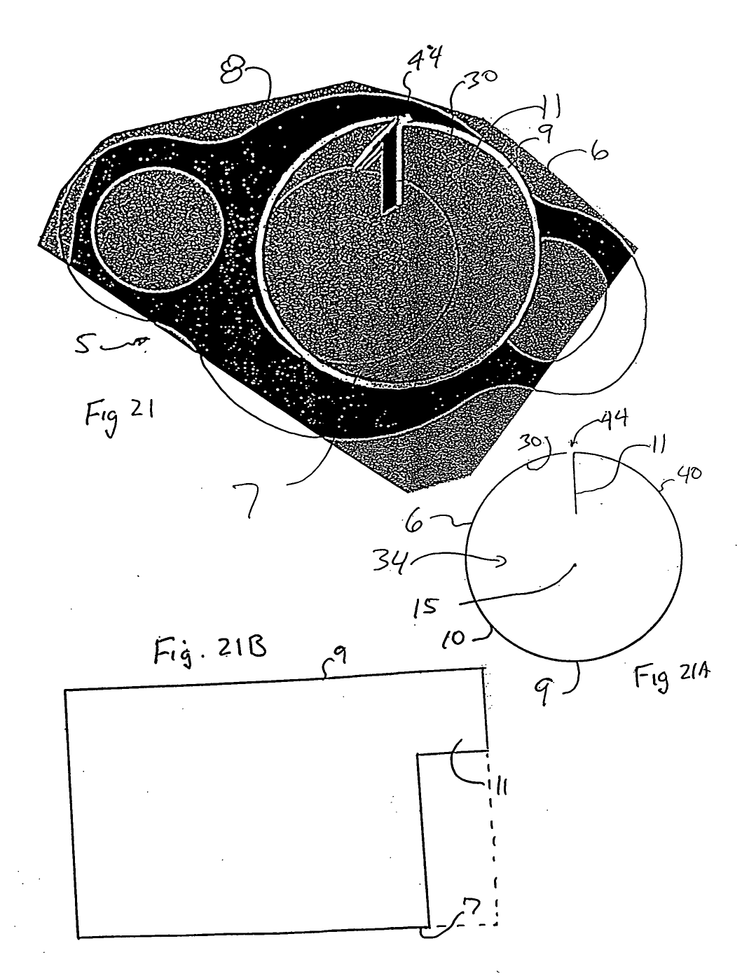

Turning now to FIG. 20, a further variation of the tubular member and a further blade variation are shown. According to this embodiment, the tubular member is not cylindrical but is, in stead, octagonal in transverse cross section. In addition, the blade 11 comprises a first pair of first and second blades 11′, 11′″ and a second pair of first and second blades 11″, 11″″ which are all accommodated within the interior region 34 of the tubular member 6. The first pair of blades 11′, 11′″ lies in and defines a first plane P1 which extends parallel to and is coincident with the longitudinal axis 15 of the device 5 while the second pair of blades lies 11″, 11″″ in and defines a second plane P2 which extends parallel to and is coincident with the longitudinal axis 15 of the device 5. The first and second planes P1, P2 extend substantially normal to one another. This arrangement of the tubular member tends to form a number air or relief passages in the fruit, as the device 5 is rotated relative to the fruit, thereby assisting with room air being sucked into the apple or other fruit as the device 5 is removed, along with the core, from the apple or other fruit.

With reference now to FIGS. 21, and 21A and 21B, another embodiment of the apple coring device 5, according to the present invention, will now be described. As this embodiment is very similar to the preceding embodiments, only the differences between this embodiment and the preceding embodiments will be discussed in detail.

As can be seen in FIGS. 21 and 21A, according to this embodiment, the blade 11 comprises a single blade 11 which is accommodated within the interior region 34 of the tubular member 6. The single blade 11 lies in and defines a first plane P1 which is coincident—although this in not required—with the longitudinal axis 15 of the device 5. One edge of the single blade 11 is securely and permanently affixed with the inner surface 30 of the tubular member 6, adjacent the second end 9 of the tubular member 6 in a known manner, e.g., an adhesive, rivets, slots, welding, being formed integral therewith, etc. The substantially radially inwardly facing edge 32 of the single blade 11 is spaced from the longitudinal axis 15 of the device 5 by a distance of between about 0.25 and 0.75 inches or so. The first end 7 of the tubular member 6 is affixed to the handle 8.

The tubular member 6 with the single blade 11 is preferably stamped from a piece of sheet metal into the configuration shown in FIG. 21B. Thereafter, the sheet metal is formed into a circular or cylindrical shape an elongate cutout or gap 44 extending along the sidewall 40 of the tubular member 6 from the first end 7 to the second end 9. The elongate cutout or gap 44 forms an air passageway along the tubular member 6 which allows air to be supplied toward a base of the closed bottomed bore formed in the apple or the other fruit by the device 5 as the core is being removed therefrom as discussed above. As the sheet metal is formed into a circular or cylindrical shape the tab is bent inward to form the single blade 11. It is to be appreciated that although the device 5 is describe as having a single blade 11, as one skill in the art would appreciate, any one of the other disclosed blade arrangements may be utilized in this embodiment.

The length of the tubular member 6 from the cutting edge 10 to the proximate surface of the handle 8 is about 1 inch to 2.5 inches or so, preferably about 1.7 inches and the inside diameter of the tubular member 6 is about 0.25 inches to 2 inches or so, preferably about 1 inch. The blade 11 has a thickness of about 0.015 inches, an axial length of between about 0.05 inches to 2.5 inches or so, preferably about 0.25 inches or so and a radial width of about 0.15 inches to 0.75 inches or so, preferably about 0.25 inches or so. This embodiment operates in a similar fashion to the previously discussed embodiments.

Preferably the cutting edge 10 of the tubular member 6 is circular and the member cutting edge 10 and the cutting edge 17 of the blade(s) 11 all lie in a cutting plane CP as this will assist the device in creating a substantially flat bottom for the closed bottom bore to be formed in the apple or other fruit.

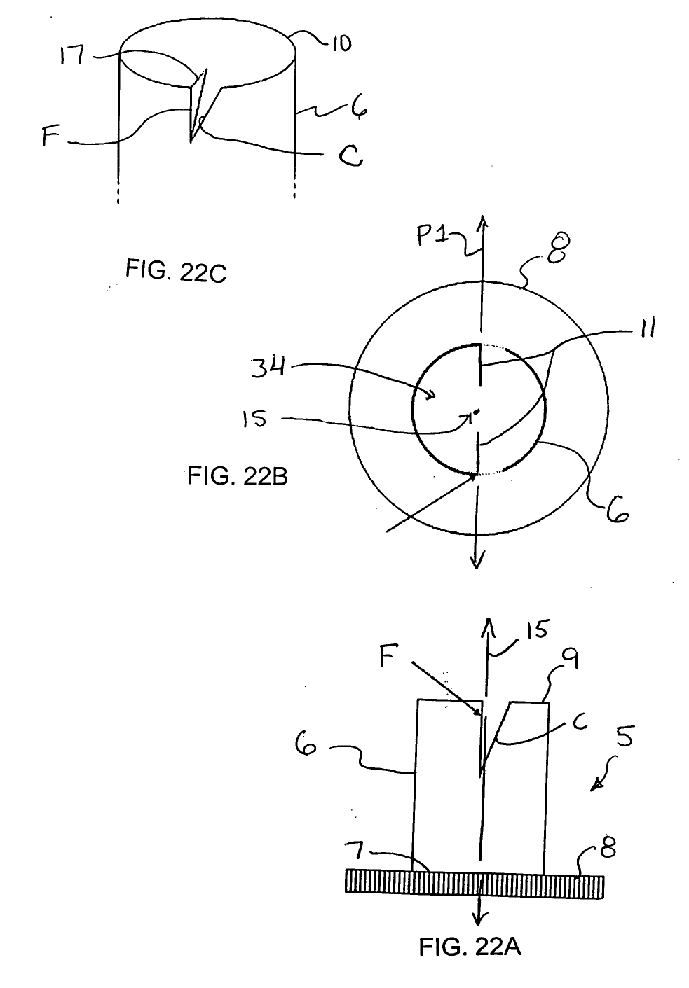

With reference now to FIGS. 22A-C, still another embodiment of the apple coring device 5 according to the present invention will now be described. As this embodiment is very similar to the previous embodiments, only the differences between this embodiment and the previous embodiments will be discussed in detail.

As can be seen in FIGS. 22A-C, according to this embodiment, the blade 11 comprises a pair of blades 11 which are both located within the interior region 34 of the tubular member 6. The pair of blades 11 lie in and define a first plane P1 which is coincident—although this in not required—with the longitudinal axis 15 of the device 5. The supporting edge of each blade 11 is formed from a portion of the side wall of the tubular member 6. That is, a diagonal cut C is made in the side wall of the tubular member 6 from the second end 9 toward, but not all the way to, the first end 7, i.e., the cut C only extends generally less than half way along the side wall. Thereafter, the free end of the cut side wall is bent inwardly along a fold line F, extending parallel to the longitudinal axis 15 of the apple coring device 5, such that the inwardly directed triangular side wall portion forms the cutting blade 11. The substantially radially inwardly facing free end of each blade 11 is spaced from the longitudinal axis 15 of the device 5 by a distance of between about 0.125 and 0.75 inches or so. The first end 7 of the tubular member 6 is affixed to the handle 8 in a conventional manner.

The tubular member 6 with the integral pair of blades 11 is preferably stamped from a single piece of sheet metal into the configuration shown in FIG. 22B. The length of the tubular member 6 from the cutting edge 10 to the proximate surface of the handle 8 is about 1 inch to 2.5 inches or so, preferably about 1.7 inches and the inside diameter of the tubular member 6 is about 0.25 inches to 2 inches or so, preferably about 1 inch. The blade 11 has a thickness of about 0.015 inches, an axial length of between about 0.05 inches to 2.5 inches or so, preferably about 0.25 inches or so and a radial width of about 0.15 inches to 0.75 inches or so, preferably about 0.25 inches or so. This embodiment operates in a similar fashion to the previously discussed embodiments. Preferably the cutting edge 10 of the tubular member 6 is circular and the member cutting edge 10 and the cutting edge 17 of the blade(s) 11 all lie in a cutting plane CP as this will assist the device in creating a substantially flat bottom for the closed bottom bore to be formed in the apple or other fruit.

Each one of the above discussed embodiments may be equipped with a depth stop, e.g., one or more removable/adjustable ring(s), spacer(s), etc. or some other conventional adjustable stop member may be provided on the exterior surface of the tubular member 6 to limit the amount that the tubular member 6 can penetrate into the fruit. The depth stop facilitates formation of uniform depth closed end bores in the fruit. For many applications, the handle 8 functions as the stop member.

Since certain changes may be made in the above described improved fruit coring device, without departing from the spirit and scope of the invention herein involved, it is intended that all of the subject matter of the above description or shown in the accompanying drawings shall be interpreted merely as examples illustrating the inventive concept herein and shall not be construed as limiting the invention.

### REFERENCE NUMBERS

1 blade
2 edges
3 handle
4 pointed end
5 apple coring device
6 tubular member
7 one end
8 handle
9 opposite end
10 cutting edge
11 blade
12 projections
13 openings
14 tapers
15 longitudinal axis
16 width
17 cutting edge
18 slots
19 thickness
20 width
21 ring
22 serrated edge
30 inner surface
32 radially inwardly facing edges
33 legs or other supports
34 interior region
36 opposed ends
38 recess
40 sidewall
44 cutout
50 opening
52 wire
P1 first plane
P2 second plane
P3 third plane
P4 fourth plane

1. A fruit coring device comprising:
a handle; and
a cutting member having a leading cutting member edge, and the cutting member being affixed to the handle;
at least one cutting surface projecting inwardly from the cutting member adjacent the cutting member edge, the at least one cutting surface having a cutting surface edge which is located adjacent a plane defined by the cutting member edge to facilitate formation of a closed bottom bore within fruit during use of the device.

2. The fruit coring device according to claim 1, wherein the at least one cutting surface defines a blade plane which is coincident with a longitudinal axis defined by the cutting member.

3. The fruit coring device according to claim 1, wherein the at least one cutting surface defines a blade plane which is spaced from a longitudinal axis defined by the cutting member.

4. The fruit coring device according to claim 1, wherein the at least one cutting surface comprises first and second blades which are accommodated within an interior region of the cutting member and the first and second blades both lie within a blade plane.

5. The fruit coring device according to claim 4, wherein the blade plane defined by the first and second blades is coincident with a longitudinal axis defined by the cutting member.

6. The fruit coring device according to claim 4, wherein the blade plane defined by the first and second blades is spaced from a longitudinal axis defined by the cutting member.

7. The fruit coring device according to claim 1, wherein the at least one cutting surface comprises first and second blades which are accommodated within an interior region of the cutting member, the first blade lies within a first blade plane and the second blade lies within a second blade plane, and the first blade plane extends substantially normal to the second blade plane.

8. The fruit coring device according to claim 1, wherein the at least one cutting surface comprises first and second pairs of blades which are accommodated within an interior region of the cutting member, the first pair of blades lie within a first blade plane and the second pair of blades lie within a second blade plane, and the first blade plane extends substantially normal to the second blade plane.

9. The fruit coring device according to claim 1, wherein the at least one cutting surface comprises first and second pairs of blades which are accommodated within an interior region of the cutting member, a first of the first pair of blades lies within a first blade plane and a second of the first pair of blades lies within a third blade plane and the first and third blade planes extend substantially parallel to one another, a first of the second pair of blades lies within a second blade plane and a second of the second pair of blades lies within a fourth blade plane and the second and fourth blade planes extend substantially parallel to one another.

10. The fruit coring device according to claim 1, wherein the cylindrical cutting member has a longitudinal indentation formed along a length thereof to facilitate passage of air therealong when removing a core from fruit.

11. The fruit coring device according to claim 1, wherein the cutting member has an elongate slot formed along a length thereof to facilitate passage of air therealong when removing a core from fruit.

12. The fruit coring device according to claim 21, wherein the leading cutting member edge has at least one tapered surface formed therein; and
the cutting member edge and the cutting surface edge lie in a cutting plane.

13. The fruit coring device according to claim 1, wherein the cutting member is a tubular member with first and second ends, the first end of the cutting member carries the cutting member edge and a second end of the cutting member is coupled to the handle.

14. The fruit coring device according to claim 1, wherein the cutting member is a tubular member and at least one leg affixes the tubular member with the handle.

15. (canceled)

16. A fruit coring device comprising:
a handle; and
a tubular member having first and second ends and defining a longitudinal axis, the tubular member having an interior cavity, the first end of the tubular member being connected with the handle and the second end defining a member cutting edge; and
at least one blade having a blade cutting edge, the at least one blade being support within the interior cavity of the tubular member such that the blade cutting edge lies substantially in a plane defined by the member cutting edge.

17. The fruit coring device according to claim 16, wherein first and second blades are accommodated within the interior cavity of the circular tubular member and the first and second blades both lie within a blade plane.

18. The fruit coring device according to claim 16, wherein first and second pairs of blades are accommodated within the interior cavity of the tubular member, the first pair of blades lie within a first blade plane and the second pair of blades lie within a second blade plane, and the first blade plane extends substantially normal to the second blade plane.

19. The fruit coring device according to claim 16, wherein first and second pairs of blades are accommodated within the interior cavity of the circular tubular member, one of the first pair of blades lies within a first blade plane and the other of the first pair of blades lies within a third blade plane and the first and third blade planes extend substantially parallel to one another, one of the second pair of blades lies within a second blade plane and the other of the second pair of blades lies within a fourth blade plane and the second and fourth blade planes extend substantially parallel to one another.

20. (canceled)

21. A fruit coring device comprising:
a handle;
a tubular member having first and second opposed ends and defining a longitudinal axis and the tubular member defining an interior region, the first end of the tubular member being directly connected with the handle, and the second end defining a member cutting edge;
the handle having first and second opposed extensions which extend away from the longitudinal axis of the tubular member to facilitate rotation of the fruit coring device;
a blade cutting edge comprising first and second inwardly directed blades which are accommodated within the interior cavity of the tubular member, the first and second inwardly directed blades both lie within a blade plane, and inner most ends of the first and second inwardly directed blades being spaced from one another;
the blade plane being substantially coincident with the longitudinal axis of the tubular member; and
the blade cutting edge lying substantially in a plane defined by the member cutting edge.

22. The fruit coring device according to claim 21, wherein the tubular member and the first and second inwardly directed blades are formed from a single a piece of metal, and the first and second inwardly directed blades are bent inwardly toward the longitudinal axis.
